(19) United States
(12) Patent Application Publication
(10) Pub. No.: US 2007/0133228 A1
(43) Pub. Date: Jun. 14, 2007

(54) BACK LIGHT MODULE

(75) Inventor: HAN-JUNG CHEN, HSINCHU (TW)

Correspondence Address: J C PATENTS, INC., 4 VENTURE, SUITE 250, IRVINE, CA, 92618, US

(73) Assignee: NANO PRECISION CORPORATION, HSINCHU (TW)

(21) Appl. No.: 11/556,832

(22) Filed: Nov. 6, 2006

(30) Foreign Application Priority Data
Dec. 12, 2005 (TW) 94143852

(51) Int. Cl. F21V 7/04

(52) U.S. Cl. 362/621

(57) ABSTRACT

A back light module having a light-guiding plate and a linear light source is provided. The light-guiding plate includes a light-guiding body with a light incident surface formed thereon and an optical-path-adjusting groove disposed on the light incident surface of the light-guiding body. The linear light source is disposed beside the light incident surface. The linear light source is suitable for providing light beams to the light incident surface. Furthermore, the optical path of the light beam is adjusted by the optical-path-adjusting groove before the light entering through the light incident surface into the light-guiding body. As a result, the back light module provides illumination with a higher degree of uniformity.

### CROSS-REFERENCE TO RELATED APPLICATION

This application claims the priority benefit of Taiwan application serial no. 94143852, filed Dec. 12, 2005. All disclosure of the Taiwan application is incorporated herein by reference.

### BACKGROUND OF THE INVENTION

1. Field of the Invention

The present invention relates to a back light module. More particularly, the present invention relates to a back light module capable of providing illumination with enhanced uniformity.

2. Description of the Related Art

Liquid crystal display device mainly includes a liquid crystal display panel and a back light module. The liquid crystal display panel includes two transparent substrates and a liquid crystal layer disposed between the transparent substrates and the back light module provides light source necessary for illuminating the liquid crystal display panel. More specifically, the back light module mainly includes a light source and a light-guiding plate. The light source such as a lamp provides lights to the light-guiding plate. The light incident on the light-guiding plate is refracted or reflected before emerging from the emergent surface of the light-guiding plate to provide the light necessary for illuminating the liquid crystal panel. However, due to the characteristics of the light, dark corner problem often occurs near the corner regions (the two ends of the lamp) on the light incident side of the light-guiding plate. Hence, the back light module can hardly provide the liquid crystal display panel with uniform illumination. Ultimately, the display quality of the liquid crystal display device is compromised.

### SUMMARY OF THE INVENTION

Accordingly, the present invention is directed to provide a back light module providing illumination with enhanced uniformity by adjusting the optical path.

As embodied and broadly described herein, the invention provides a back light module including a light-guiding plate and a linear light source. The light-guiding plate includes a light-guiding body with a light incident surface formed thereon and an optical-path-adjusting groove disposed on the light incident surface of the light-guiding body. The linear light source is disposed beside the light incident surface. The linear light source is suitable for providing light beams to the light incident surface, and an optical path of the light beam is adjusted by the optical-path-adjusting groove before the light beam entering the light-guiding body through the light incident surface. In one preferred embodiment of the present invention, the optical-path-adjusting groove further includes a plurality of light incident sub-surfaces connected to each other the light beams emitted from the linear light source enter the optical-path-adjusting groove. A direction of each light incident sub-surface is parallel to a direction of extension of the linear light source. Or the direction of each light incident sub-surface forms an included angle with the direction of extension of the linear light source. The light-guiding body and the optical-path-adjusting groove are formed integrally. In the present invention, the optical-path-adjusting groove is employed and the light beam is incident from the light incident surface into the light-guiding body only after its optical path has been adjusted by the optical-path-adjusting groove. As a result, the back light module provides more uniform illumination to the liquid crystal display panel.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a liquid crystal display device according to a first preferred embodiment of the present invention.

FIG. 2A is a perspective view showing a light-guiding plate and two lamps according to the first preferred embodiment of the present invention.

FIG. 2B is a perspective view showing part of the light-guiding plate in FIG. 2A.

FIG. 3 is a cross-sectional view showing the optical path of the light beams in FIG. 2A.

FIG. 4A is a perspective view showing a light-guiding plate and two lamps according to a second preferred embodiment of the present invention.

FIG. 4B is a perspective view showing part of the light-guiding plate of FIG. 4A.

FIG. 5 is a cross-sectional view showing the optical path of the lights in FIG. 4A.

FIG. 6 is a diagram showing the optical-path-adjusting groove according to a third preferred embodiment of the present invention.

FIG. 7 is a diagram showing the optical-path-adjusting groove according to a fourth preferred embodiment of the present invention.

FIG. 8 is a diagram showing the optical-path-adjusting groove according to a fifth preferred embodiment of the present invention.

FIG. 9A is a cross-sectional view of a back light module according to a sixth preferred embodiment of the present invention.

FIG. 9B is a partially magnified view of a light guiding plate shown in FIG. 9A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

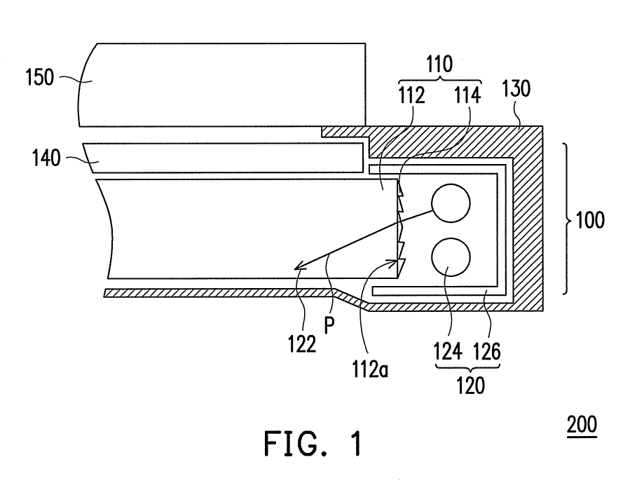

FIG. 1 is a cross-sectional view of a liquid crystal display device according to a first embodiment of the present invention. As shown in FIG. 1, a liquid crystal display device 200 includes a back light module 100 and a liquid crystal display panel 150 disposed over the back light module 100. The back light module 100 includes a light-guiding plate 110 and a linear light source 120. The light-guiding plate 110 further includes a light-guiding body 112 having a light incident surface 112a formed thereon and an optical-path-adjusting groove 114 disposed on the light incident surface 112a of the light-guiding body 112. The linear light source 120 is disposed beside the light incident surface 112a. Furthermore, the linear light source 120 is suitable for providing a light beam 122 that transmits to the optical-path-adjusting groove 114. After the light beam 122 has been adjusted by the optical-path-adjusting groove 114, the light beam 122 is incident into the light-guiding body 112 from the light incident surface 112a and transmits along a path P.

The linear light source 120 includes two lamps 124 and a reflector 126, for example. The lamps 124 are disposed beside the light incident surface 112a for emitting the light beam 122. The reflector 126 encloses the lamps 124 so that the light beam 122 emitted from the lamps 124 is reflected into the light-guiding plate 110 and increases the light utilization rate. Furthermore, in order to fix the light-guiding plate 110 and the linear light source 120, a metallic bezel 130 is also used to enclose the back light module 100. Additionally, a set of optical films 140 is also added to a space between the back light module 100 and the liquid crystal display panel 150 for improving the display quality of the liquid crystal display device 200.

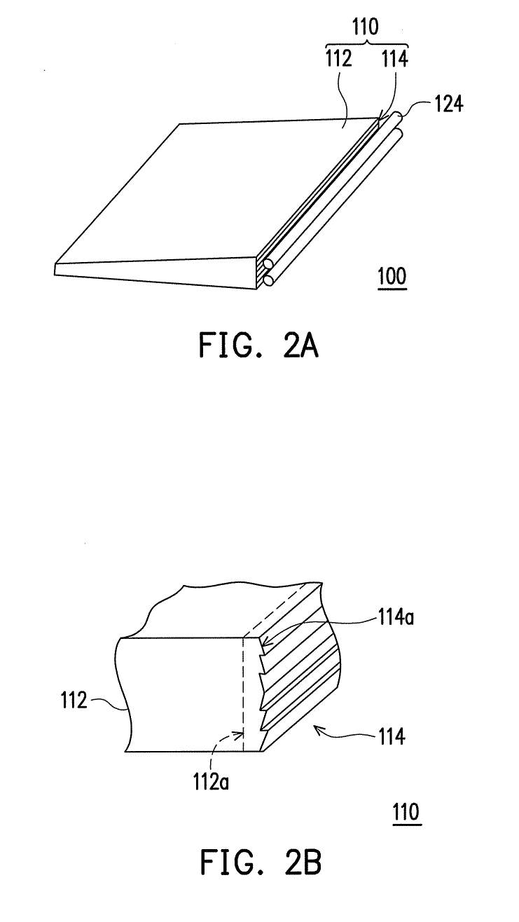

As shown in FIGS. 1, 2A and 2B, the optical-path-adjusting groove 114 in the present embodiment includes a plurality of connected light incident sub-surfaces 114a. The light beam 122 emitted from the linear light source 120 enters the optical-path-adjusting groove 114 through the light incident sub-surfaces 114a. Each light incident sub-surface 114a extends in a direction parallel to a direction of extension of the linear light source 120. Each light incident sub-surface 114a is a plane or a curve surface, for example.

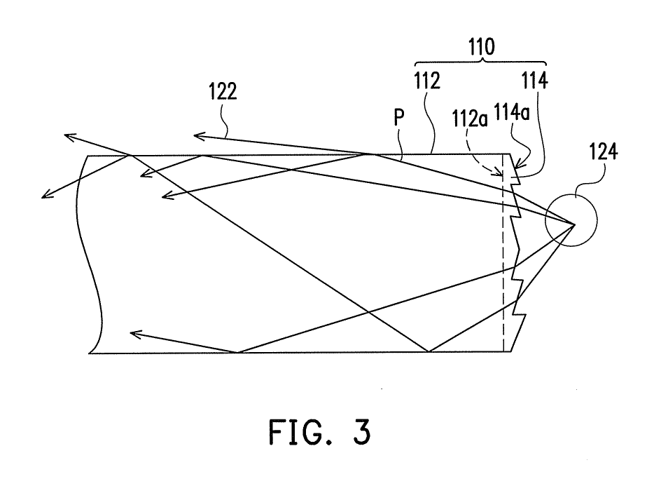

FIG. 3 is a cross-sectional view showing the optical path of the lights in FIG. 2A. To simplify the explanation, only a single lamp 124 instead of the linear light source 120 is shown. Moreover, the reflector 126 and the optical path associated with the light reflected from the reflector 126 are omitted. As shown in FIG. 3, when the lamp 124 provides a light beam 122 to the light-guiding plate 110, the light beam 122 transmits into the optical-path-adjusting groove 114 through the light incident sub-surface 114a. Adopting the light refraction theory, the path P of the light beam 122 is adjusted before the light beam 122 entering the light-guiding body 112 via the light incident surface 112a. Similarly, the light beam 122 reflected by the reflector 126 (shown in FIG. 1) also transmits through the light incident sub-surface 114a before getting into the optical-path-adjusting groove 114. After the optical-path-adjusting groove 114 has adjusted the direction of the path P, the light beam 122 enters the light-guiding body 112. Therefore, the back light module 100 provides uniform illumination and improves the display quality of the display device 200.

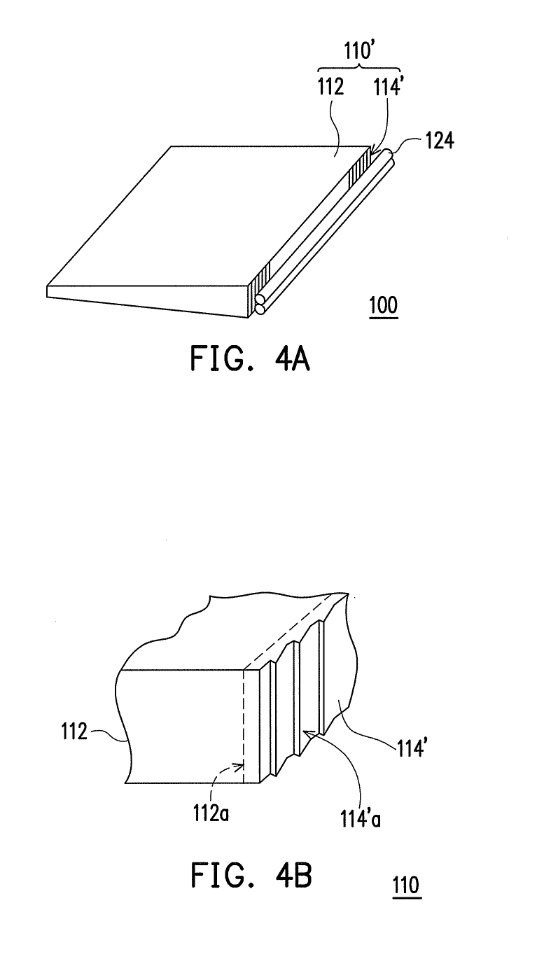

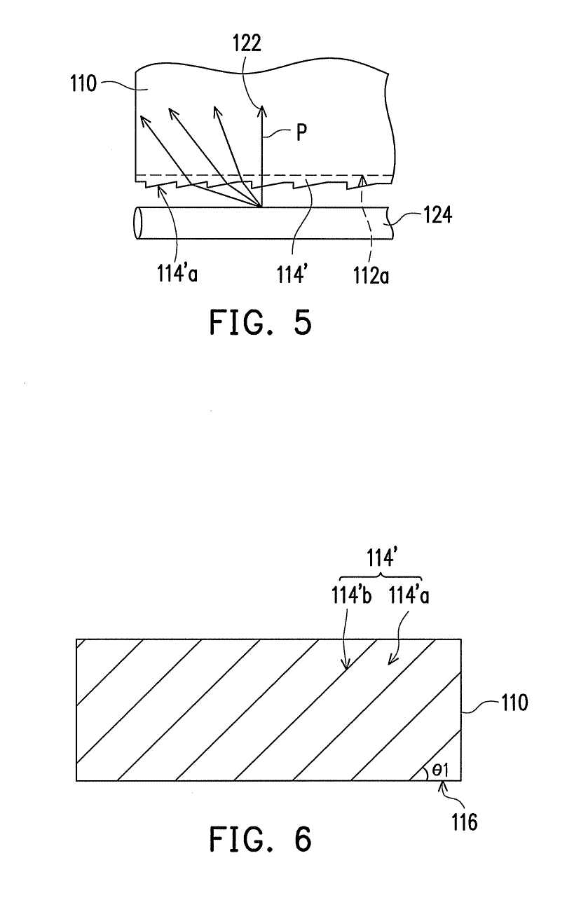

FIG. 4A is a perspective view showing a light-guiding plate and two lamps according to a second preferred embodiment of the present invention. FIG. 4B is a perspective view showing part of the light-guiding plate in FIG. 4A. FIG. 5 is a cross-sectional view showing the optical path of the lights in FIG. 4A. Referring to FIGS. 4A, 4B, and 5, the present embodiment differs from the previous embodiment in that the optical-path-adjusting groove 114′ is disposed on the light incident surface 112a in areas that correspond to the two ends of the lamp 124. Furthermore, a direction of the extension of the light incident sub-surfaces 114a′ of the optical-path-adjusting groove 114′ is perpendicular to the direction of extension of the linear light source 120. Therefore, looking from the top of the light-guiding plate 110, the optical-path-adjusting groove 114′ adjusts the advancing path P of the light beam 122 when the light beam 122 enters the optical-path-adjusting groove 114′ through the light incident sub-surface 114′a. Hence, some of the light beam 122 entering the light-guiding body 112 of the back light module 100 is deflected towards the two ends of the lamp 124. Ultimately, corner darkening due to an insufficient projection of the light beam 122 towards the two ends of the lamp is effectively reduced.

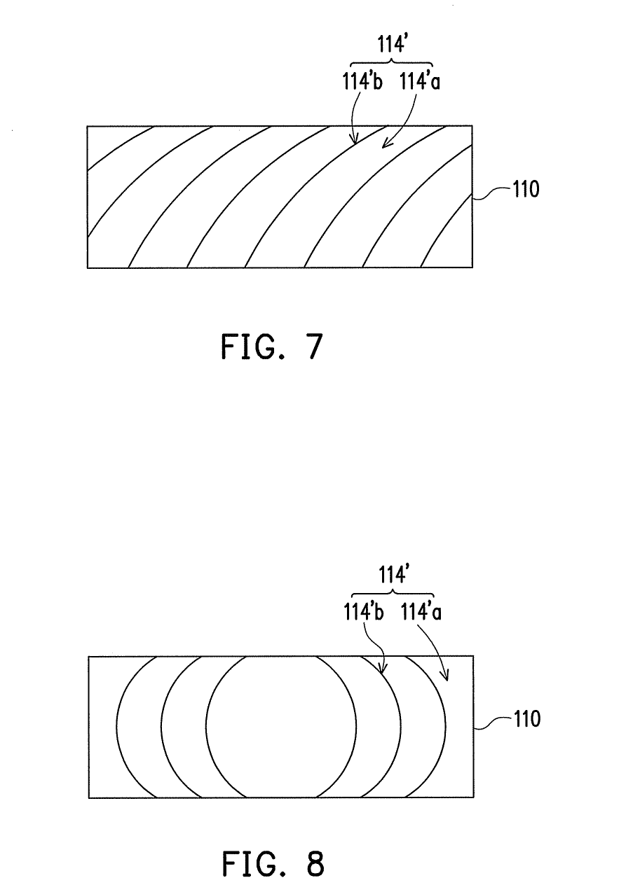

FIGS. 6, 7 and 8 are diagrams showing a few patterns of the optical-path-adjusting groove according to the embodiments of the present invention. According to the description of the foregoing embodiment, the present invention utilizes optical refraction theory to modify the path P of the light beam 122 so that the back light module 100 provides more uniform illumination. Thus, according to an aspect of the present invention, the pattern of the optical-path-adjusting groove 114′ can have the following modifications depending on the actual requirements. For example, in an optical path adjusting structure 114′, every pair of adjacent light incident surface 114′a have a crest line 114′b therebetween. The crest line 114′b can be a straight line with an included angle θ1 between the crest line 114′b and a bottom surface 116 of the light-guiding plate 110 as shown in FIG. 6. Alternatively, the crest lines 114′b on the optical path adjusting structure 114′ can be non-symmetrical curves with a regular or non-regular arrangement as shown in FIG. 7. Obviously, the crest line 114′b on the optical path adjusting structure 114′ can be curves arranged symmetrically as shown in FIG. 8.

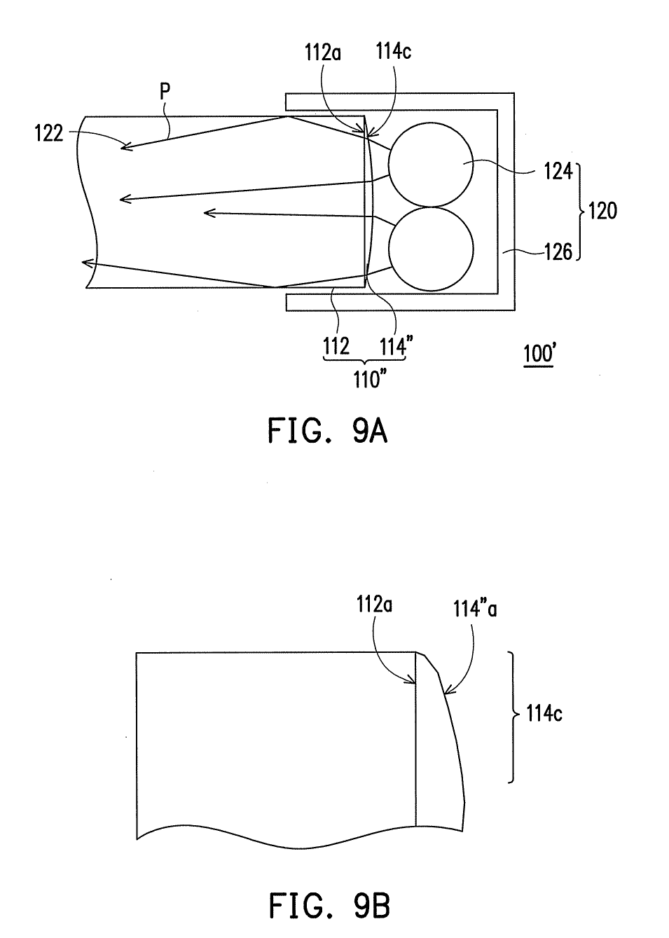

FIG. 9A is a cross-sectional view of a back light module according to a sixth embodiment of the present invention. FIG. 9B is a partially magnified view of a light guiding plate shown in FIG. 9A. The back light module 100′ in FIG. 9A is similar to the back light module 100 in FIG. 1 so that an identical or similar label refers to an identical or similar component whose description is not repeated here. As shown in FIGS. 9A and 9B, the main difference of the present embodiment from the previous embodiment is that the optical-path-adjusting groove 114″ in the present embodiment has a continuous light incident sub-surface 114c. Furthermore, the continuous light incident sub-surface 114c is a plane or a curve surface, for example. More specifically, the light incident sub-surface 114c is a curve surface constructed with a plurality of non-continuous light incident sub-surfaces 114″a. When the lamp 124 provides a light beam 122, the light beam 122 enters the optical-path-adjusting groove 114″ through the curve surface including a number of light incident sub-surfaces 114c. Thereafter, the optical-path-adjusting groove 114″ adjusts the path P of the light beam 122. Then, the light beam 122 enters the light-guiding body 112 via the light incident surface 112a. As a result, the back light module 100′ provides more uniform illumination.

In the foregoing embodiment, the light-guiding body 112 and the optical-path-adjusting groove 114′ are formed integrally. Alternatively, the optical-path-adjusting groove 114′ is fabricated and then the optical-path-adjusting groove 114′ is attached to the light-guiding body 112.

In summary, the present invention utilizes the optical-path-adjusting groove to bend the light incident through refraction so that the path of the light beam entering the light-guiding body is adjusted to provide illumination with enhanced uniformity. Hence, the display quality of the liquid crystal display device is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back light module, comprising:
a light-guiding plate, comprising:
a light-guiding body having an light incident surface formed thereon; and
an optical-path-adjusting groove disposed on the light incident surface; and
a linear light source disposed beside the light incident surface, wherein the linear light source is suitable for providing a light beam, and an optical path of the light beam is adjusted by the optical-path-adjusting groove through refractions before the light beam entering the light-guiding body through the light beam incident surface.

2. The back light module of claim 1, wherein the optical-path-adjusting groove further comprises a plurality of light incident sub-surfaces connected to each others such that the light beam emitted from the linear light source enters the optical-path-adjusting groove through the light incident sub-surfaces.

3. The back light module of claim 2, wherein each light incident sub-surface is a plane surface or a curve surface.

4. The back light module of claim 2, wherein a direction of extension of each light incident sub-surface is parallel to a direction of extension of the linear light source.

5. The back light module of claim 2, wherein a direction of extension of each light incident sub-surface forms an included angle with a direction of extension of the linear light source.

6. The back light module of claim 1, wherein the optical-path-adjusting groove has a continuous light incident sub-surface.

7. The back light module of claim 6, wherein the continuous light incident sub-surface is a plane surface or a curve surface.

8. The back light module of claim 1, wherein the light-guiding body and the optical-path-adjusting groove are formed integrally.
